(19) United States
(12) Patent Application Publication
(10) Pub. No.: US 2019/0308157 A1
(43) Pub. Date: Oct. 10, 2019

(54) One-step Dual Heater Based Flow Synthesis Setup for Synthesis of Inorganic Particles in Near Ambient Conditions

(71) Applicant: COMSATS University Islamabad, Islamabad (PK)

(72) Inventors: Aqif Anwar CHAUDHRY, Islamabad (PK); Kashif IJAZ, Islamabad (PK)

(21) Appl. No.: 16/373,185

(22) Filed: Apr. 2, 2019

(30) Foreign Application Priority Data
Apr. 9, 2018 (PK) 228/2018

(51) Int. Cl. B01J 14/00; B01J 4/00; B01J 19/00; C01B 25/32

(52) U.S. Cl. CPC B01J 14/00; B01J 4/008; B01J 19/0053; B01J 19/0013; C01B 25/32; C01P 2002/70; B82Y 40/00; C01P 2002/82; C01P 2004/64; B01J 2204/002; B01J 2219/00033; B01J 2219/00164; C01P 2002/88

(57) ABSTRACT

A method for synthesis of inorganic nanoparticles is disclosed. This synthesis method is single step, based on two heaters and functions using near ambient conditions. This flow method can be used to synthesize a range of inorganic particles. Synthesis of stoichiometric and non-stoichiometric hydroxyapatite with ranging thermal stabilities has been shown in this application. These materials find wide applications as biomaterials, in the form of additives to polymer based composites, for bone filling applications and also as coatings on metallic substrates.

### CROSS REFERENCE TO RELATED APPLICATION

This application claims priority from and the benefit of Parkistan Patent Application No. 228/2018, filed on Apr. 9, 2018, which is hereby incorporated by reference for all purposes as if fully set forth herein.

### BACKGROUND

### Field

Exemplary embodiments/implementations of the invention relate generally to synthesis of inorganic particles and, more specifically, to a one-step dual heater based flow synthesis setup for synthesis of inorganic particles in near ambient conditions.

### Discussion of the Background

Inorganic particles such as calcium phosphates and oxides find extensive industrial and biomedical applications. Current methods for synthesis of these inorganic particles include wet-chemical and solid state methods. Wet-chemical methods include co-precipitation, batch hydrothermal synthesis, hydrothermal high temperature and pressure flow synthesis and emulsion methods. These methods require long synthesis durations, subsequent heat-treatment steps to attain stoichiometry or crystallinity, organic additives which require a subsequent burn off step or expensive kits which operate under severe conditions. Solid state methods on the other hand are prone to impurities as grinding surfaces which provide the energy for reactions to take place often result in wear debris that may get incorporated in the product and influence its performance. Moreover, solid state methods often require long reactions durations and intensive energy input for sustained periods of time. Current flow synthesis routes rely on complex high temperature and high pressure systems—which poses challenges related to scale up and commercial potential. Therefore, there is a need for a single, one-step, low-tech method that allows easy access to inorganic particles with tailorable properties. The investigators report a novel flow synthesis system that relies on easy to use equipment and results in products with tailorable properties.

The above information disclosed in this Background section is only for understanding of the background of the inventive concepts, and, therefore, it may contain information that does not constitute prior art.

### SUMMARY

Devices constructed and methods according to exemplary embodiments of the invention are capable of providing a one-step dual heater based flow synthesis setup for synthesis of inorganic particles in near ambient conditions.

Additional features of the inventive concepts will be set forth in the description which follows, and in part will be apparent from the description, or may be learned by practice of the inventive concepts.

According to one or more embodiments of the invention, a system includes: a first pump, a second pump, a T-piece reactor, a first heater, and a second heater. The first pump and the second pump are connected to respective inputs of the T-piece reactor, an output of the T-piece reactor is connected to an input of the first heater, and an output of the first heater is connected to an input of the second heater.

The first pump may send a first solution to the T-piece reactor.

The second pump may send a second solution to the T-piece reactor.

The first solution may react with the second solution in T-piece reactor.

The reaction solution of T-piece reactor may be passed through the first heater.

The solution from the first heater may be moved through the second heater.

The solution may exit from the second heater and be collected in a container in a continuous manner.

The system may be used for continuous flow synthesis.

The system may be used for the synthesis of inorganic particles and nanoparticles.

The system may be used for the synthesis of inorganic particles and nanoparticles of a single phase.

The system may be used for the synthesis of inorganic particles and nanoparticles belonging to different phases.

The system may be used for the synthesis of inorganic particles and nanoparticles grafted with organic groups.

The system may be used for synthesis based on variable flow rates.

The system may be used for varying flow rates of all feeds independently.

The system may be used to vary reaction times based on flow rates.

The system may be is used to increase reactions times by increase in length of tubing in the first heater.

The system may be used to increase reactions times by increase in length of tubing in the second heater.

The system may be used to influence reaction yield by using different concentrations.

The system may be is used to synthesize inorganic particles with varying crystallinity.

The system may be used to vary reaction temperatures.

In an exemplary embodiment, a length of the first heater and/or a length of the second heater may be configured to be increased to increase crystallinity.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 illustrates a flow synthesis system in accordance with an exemplary embodiment of the inventive concepts.

FIG. 2 is a schematic illustration of the flow of suspension into a pair of heaters prior to collection, in accordance with an exemplary embodiment.

FIG. 3 illustrates an X-Ray diffraction analysis for six synthesized samples.

FIGS. 4A, 4B, and 4C show graphs of a Differential Scanning calorimetry and Thermo Gravimetric Analysis of samples synthesized using 0.8-meter length at flow rates of 20, 30 and 40 ml/min, respectively.

FIGS. 5A, 5B, and 5C show graphs of a Differential Scanning calorimetry and Thermo Gravimetric Analysis curves of samples synthesized using 21-meter length at flow rates of 20, 30 and 40 ml/min, respectively.

FIG. 6 illustrates a Fourier Transform Infra Red (FTIR) Spectra for samples synthesized using 8-meter length at combined flow rates of (a) 20 ml/min (b) 30 ml/min and (c) 40 ml/min.

FIG. 7 illustrates a FTIR Spectra for samples synthesized using 21-meter length at combined flow rates of (a) 20 ml/min (b) 30 ml/min and (c) 40 ml/min.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

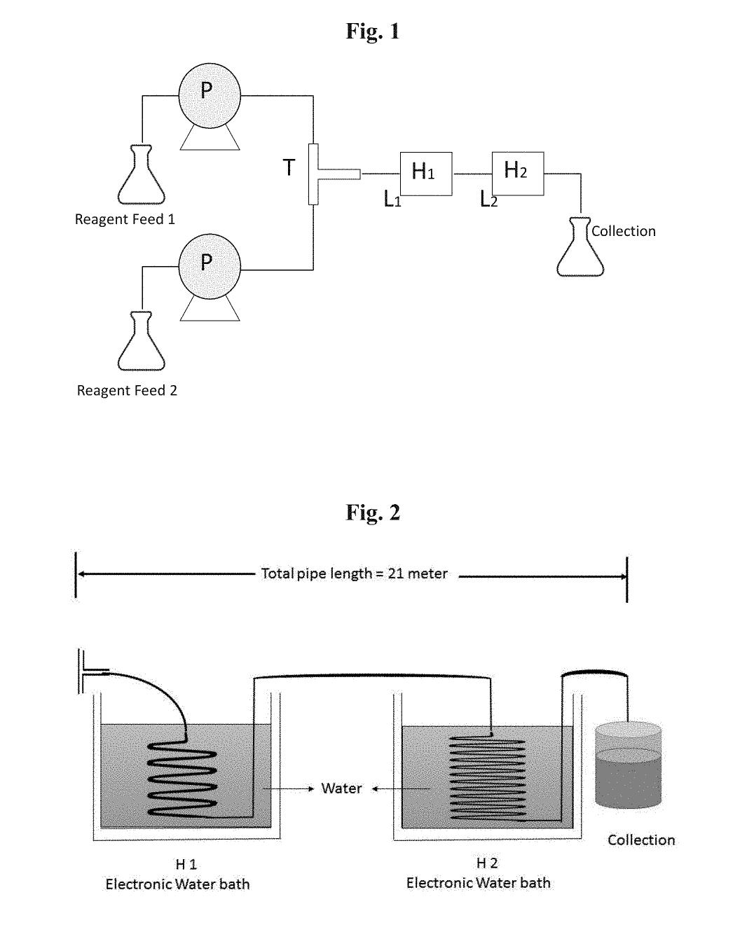

An exemplary embodiment of a flow synthesis system is disclosed in FIG. 1. The flow synthesis system consists of two pumps P which pump the requisite reagent solutions of Reagent Feed 1 and Reagent Feed 2 into a T-piece reactor T (e.g., through ⅛-inch external diameter PTFE tubing) where the reaction takes place. After the reaction at the T-piece T, the resulting suspension then flows into (and through) a heater H1 which is essentially a water bath maintained at temperature T1. T1 is the temperature that allows the suspension flowing through the ⅛-inch PTFE tubing to attain temperature T2, which is a requirement for the reaction to take place. The suspension then flows into a second heater H2, which is another water bath maintained at T2. The length of the pipe through this hot zone depends on the need for residence time at T2. The suspension then exits from heater H2 and is collected in a container in a continuous manner. These suspensions are then filtered, washed and dried prior to characterization.

As schematically shown in FIG. 1, L1=Length of tubing through H1 and L2=Length of tubing through H2. In an exemplary embodiment, a length of the first heater H1 and/or a length of the second heater H2 may be configured to be increased to increase crystallinity.

### Example: Calcium Phosphate Synthesis Using the Flow Synthesis System

Calcium nitrate tetra hydrate [Ca (NO₃)₂.4H₂O 98%] and Diammonium hydrogen phosphate [(NH₄)₂HPO₄, 85.5%] were used for synthesis of hydroxyapatite, a calcium phosphate material. 18.2 M-Ohm-cm deionized water was used to make up solutions. 500 mL of 0.3 Molar Diammonium hydrogen phosphate solution were pumped along with 500 mL of 0.5 Molar Calcium nitrate tetrahydrate solution using HPLC pumps at flow rates of 10, 15 and 20 mL/min. The combined flow rates hence after the reaction at a stainless steel T-piece reactor were 20, 30 and 40 mL/min respectively. The pH of both solutions was adjusted to pH 10 using ammonium hydroxide prior to reaction. The ⅛-inch external diameter PTFE tubing then passed through the first hot zone—a water bath maintained at 80° C. The length of the tubing associated with this water bath (L₁) was 0.8 meters and it heated the suspension to near 60° C. Reactions (at the 3 aforementioned flow rates) were carried out once with suspension collection after exit from H1 and then repeated (at the 3 aforementioned flow rates) but collected after H2. In a typical reaction the suspension then flows out of H1 and into the second water bath, H2. The length of the tubing associated with this water bath was 20.2 meters bringing the total length to 21 meters. FIG. 2 illustrates a schematic of an exemplary embodiment of the arrangement of both the hot zones (H1 and H2) as used herein. H2 was maintained at 60° C. and the system exit temperatures of the suspensions in all cases were near 60° C. The obtained suspensions were then centrifuged and washed twice by deionized water. The samples were then oven dried at 80° C. for 24 hours in a drying oven. All reaction parameters are presented in Table 1, showing reaction parameter details of reactions carried out in two groups, each group containing three reactions corresponding to three different flow rates.

TABLE 1

| | | Flow Rates (ml/min) | | | Initial pH of solutions | | | | | |
|---|---|---|---|---|---|---|---|---|---|---|
| | Effective | | Diammonium | | | Diammonium | | Suspension | | |
| | Length | Calcium | hydrogen | Residence | Calcium | hydrogen | Suspension | Temperature | Suspension | Yield |
| Groups | (m) | Nitrate | phosphate | time(min) | Nitrate | phosphate | Volume (ml) | (° C.) | pH | (g) |
| 1 | 0.8 | 10 | 10 | 0.25 | 10 | 10 | 300 | 62 | 8 | 7.17 |
| | | 15 | 15 | 0.17 | 10 | 10 | 300 | 59 | 8 | 7.22 |
| | | 20 | 20 | 0.13 | 10 | 10 | 300 | 57 | 8 | 6.85 |
| 2 | 21 | 10 | 10 | 6.59 | 10 | 10 | 380 | 63 | 8 | 7.53 |
| | | 15 | 15 | 4.30 | 10 | 10 | 395 | 59 | 8 | 7.75 |
| | | 20 | 20 | 3.20 | 10 | 10 | 410 | 58 | 9 | 7.50 |

XRD (X-ray diffraction) data was collected on an X-Pert Pro X-ray diffractometer using Cu-Kα radiation over the 2 range 5-700 with a step size of 0.010 and a count time 1 second per step. Surface area measurements (using N₂ gas adsorption method) were performed on a Micromeritics Gemini analyzer; powders were first degassed at 1000 C for 2 hours at 10° C./min ramp prior to analyses. Photo acoustic accessory was used to collect FTIR spectra in the 4000-400 cm-1 wavenumber range averaging 256 scans with 8 cm-1 spectral resolution. Thermal studies (TGA/DSC) were carried out using a TA Instruments SDTQ600 using a 5° C./min ramp from room temperature to 1200° C. under nitrogen atmosphere.

X-Ray Diffraction

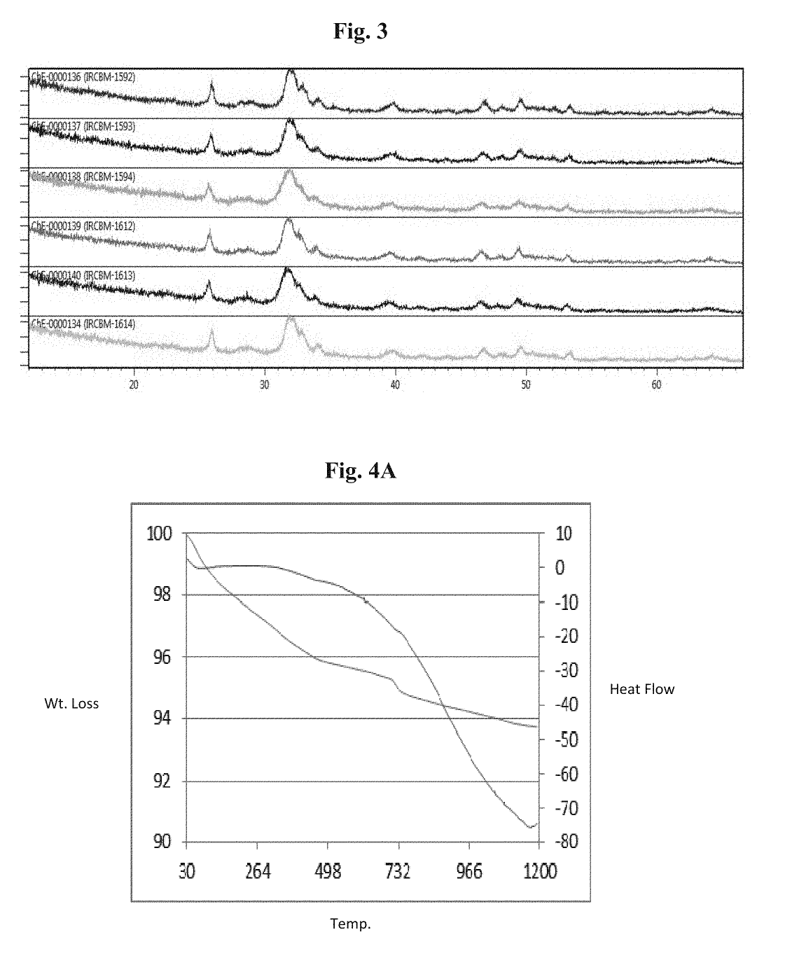

FIG. 3 shows the XRD analysis for all the six synthesized samples (a)-(f). All XRD patterns gave a good match to ICDD pattern 09-432 which corresponds to phase pure hydroxyapatite. The broad nature of the peak and lesser number of peaks suggests that the precipitated hydroxyapatite particles are semi-crystalline and nanosized.

Thermal Behavior

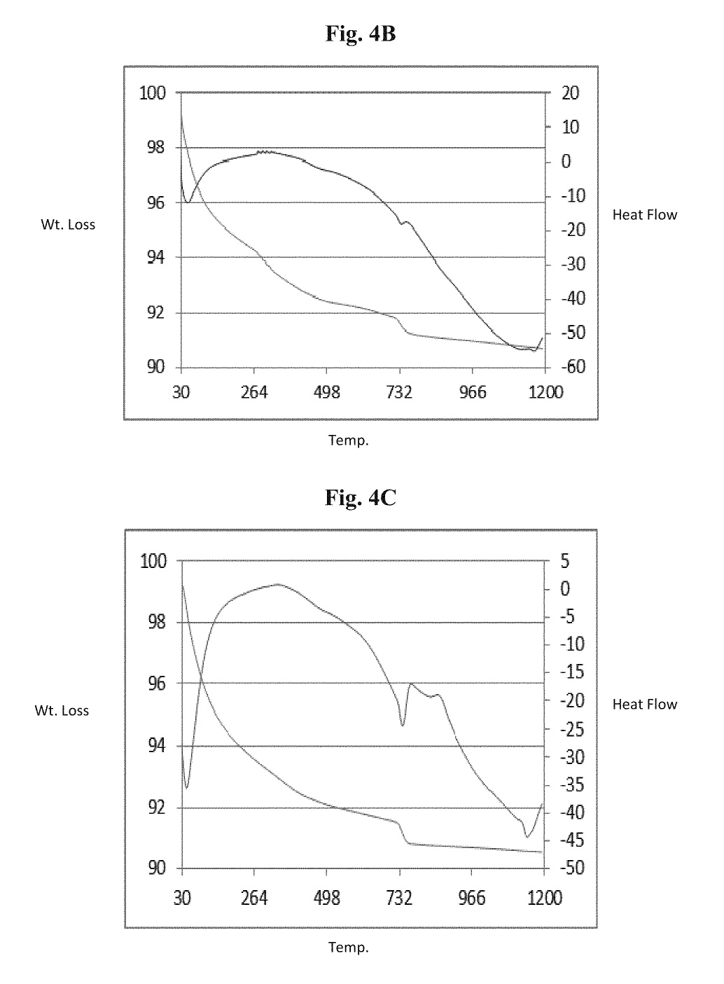

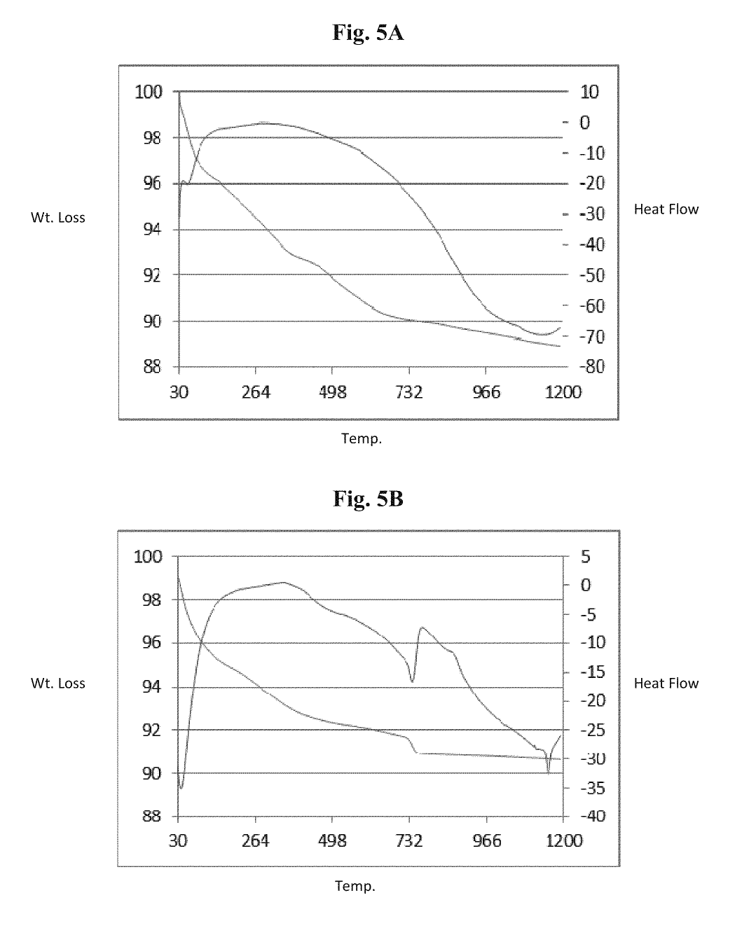

FIGS. 4A, 4B, and 4C show a Differential Scanning calorimetry and Thermo Gravimetric Analysis curves of samples synthesized using 0.8-meter length at flow rates of 20, 30 and 40 ml/min, respectively. FIGS. 5A, 5B, and 5C show the DSC and TGA curves of samples synthesized using 21-meter length at flow rates of 20, 30 and 40 ml/min, respectively. Weight loss in all the samples can be broadly summed up in three regions. Between 30° C. and 200° C., the weight loss is attributed to loss of weakly adsorbed water. Between 200° C. and 600° C. the weight loss can be attributed to loss of lattice water. Between 600° C. and 1200° C. the weight loss can be attributed to loss of CO2 and with the exception of 1 samples, decomposition. This decomposition takes place around 750° C. and is attributed to calcium deficient hydroxyapatite converting into stoichiometric hydroxyapatite, tricalcicum phosphate and water. The characteristic dip in the TGA curve around this temperature was not observed in FIG. 5A corresponding to sample synthesized at 20 ml/min combined flow rate using 21-meter length. Within the parameters explored this combination represents the maximum residence time for the suspension—hence the temperature stability of the synthesize hydroxyapatite phase.

FIG. 3 shows the X-Ray Diffraction patterns of samples synthesized using: (a) 0.8 m length and 20 ml/min combined flow rate of calcium and phosphate feed; (b) 0.8 m length and 30 ml/min flow rate; (c) 0.8 m length and 40 ml/min flow rate; (d) 21 m length and 20 ml/min flow rate; (e) 21 m length and 30 ml/min flow rate; and (f) 21 m length and 40 ml/min flow rate.

FIGS. 4A, 4B, and 4C show Differential Scanning calorimetry and Thermo Gravimetric Analysis curves for samples synthesized using 0.8-meter length at combined flow rates of: (a) 20 ml/min in FIG. 4A, (b) 30 ml/min in FIG. 4B; and (c) 40 ml/min in FIG. 4C.

FIGS. 5A, 5B, and 5C show Differential Scanning calorimetry and Thermo Gravimetric Analysis curves for samples synthesized using 21-meter length at combined flow rates of: (a) 20 ml/min in FIG. 5A; (b) 30 ml/min in FIG. 5B; and (c) 40 ml/min in FIG. 5C.

Fourier Transform Infra Red Spectroscopy

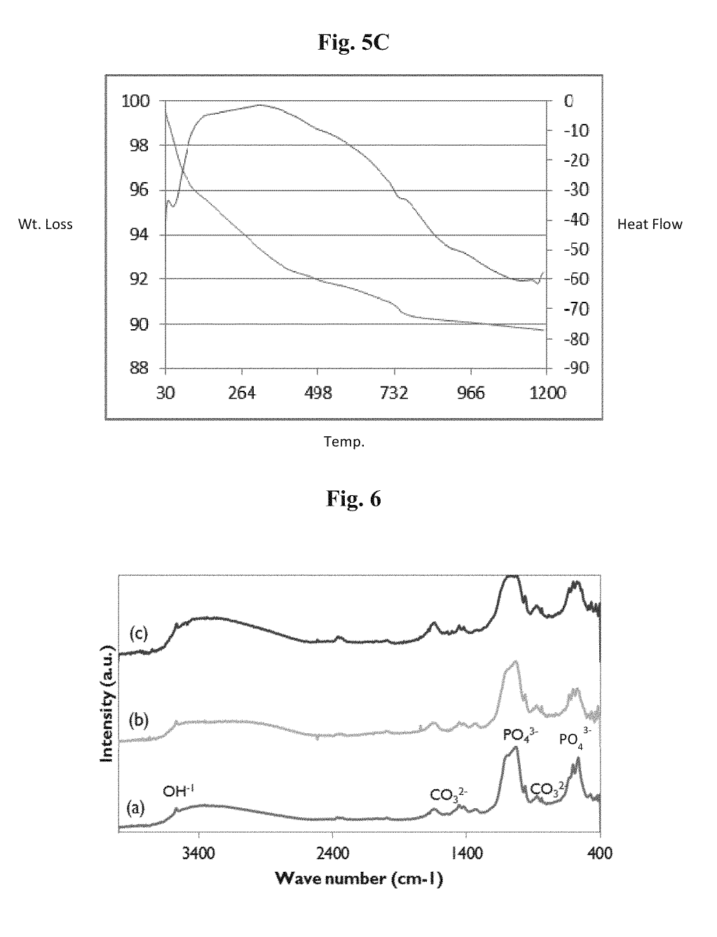

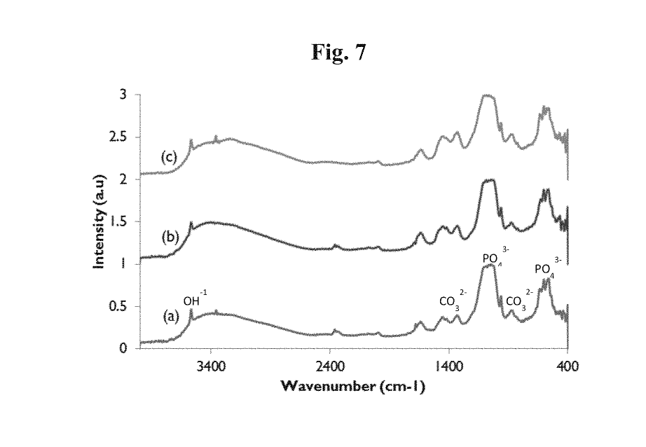

FIG. 6 shows Fourier Transform Infra Red (FTIR) Spectra for samples synthesized using 8-meter length at combined flow rates of (a) 20 ml/min (b) 30 ml/min and (c) 40 ml/min. FIG. 7 shows Fourier Transform Infra Red (FTIR) Spectra for samples synthesized using 21-meter length at combined flow rates of (a) 20 ml/min (b) 30 ml/min and (c) 40 ml/min.

Within FIG. 6 and FIG. 7, (a), (b) and (c) correspond to combined flow rates of 20 ml/min, 30 ml/min and 40 ml/min, respectively. In all the FTIR spectra in FIGS. 5A, 5B, and 5C, a peak corresponding to stretching mode of the O—H group was observed at 3560 cm⁻¹. Peaks in the 1650-1450 cm-1 range corresponded to the stretching vibrations of the C—O linkage in carbonate. Another peak at 860 cm−1 was due to the bending vibration of the O—C—O linkage in carbonate. Peaks in the 1150-1000 cm−1 range correspond to the asymmetric stretching mode of the P—O linkage in phosphate (of hydroxyapatite) while the peak at 960 cm⁻¹ corresponds symmetric stretching of the same linkage. Peak at 630 cm-1 corresponds to the vibration of the O—H group in hydroxyapatite (librational). Peaks at 602 and 567 cm⁻¹ correspond to the bending vibration of the O—P—O linkage in phosphate group in hydroxyapatite. Curves (a)-(c) in FIG. 7 show the FTIR spectra for samples synthesized in the 21 meter set up at varying flow rates. A comparison with FIG. 6 reveals that the peaks are better resolved—possibly due to increased crystallinity as a result of longer residence time in the hot zone.

Surface Area

Table 2 shows Surface Areas of samples synthesized using various geometries and flow rates.

TABLE 2

| Effective Length | Combined Flow Rate | BET |
|---|---|---|
| (meters) | (ml/min) | (m²/g) |
| 0.8 | 20 | 68 |
| | 30 | 75 |
| | 40 | 65 |
| 21 | 20 | 73 |
| | 30 | 68 |
| | 40 | 67 |

Surface area of the dried powders was determined using BET technique (based on N₂ adsorption). The surface areas did not show large variance (between 65-75 m²/g)—and point towards nanosized particles.

Some of the advantages that may be achieved by exemplary implementations/embodiments of the invention and/or exemplary methods of the invention include the development of a quick and easy method for synthesis of inorganic nanoparticles. This synthesis method is single step, based on two heaters and functions using near ambient conditions. This flow method can be used to synthesize a range of inorganic particles. Synthesis of stoichiometric and non-stoichiometric hydroxyapatite with ranging thermal stabilities has been shown in this application. These materials find wide applications as biomaterials—in the form of additives to polymer based composites, for bone filling applications and also as coatings on metallic substrates.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A system comprising:
a first pump;
a second pump;
a T-piece reactor comprising a first input, a second input, and an output;
a first heater comprising an input and an output; and
a second heater comprising an input and an output,
wherein;
the first pump and the second pump are connected to the first and second inputs of the T-piece reactor,
the output of the T-piece reactor is connected to the input of the first heater, and
the output of the first heater is connected to the input of the second heater.

2. The system of claim 1 wherein the first pump is configured to send a first solution to the T-piece reactor.

3. The system of claim 2 wherein the second pump is configured to send a second solution to the T-piece reactor.

4. The system of claim 3 wherein the T-piece reactor is configured such that the first solution reacts with the second solution in the T-piece reactor to form a reaction solution.

5. The system of claim 4, wherein T-piece reactor is configured to pass the reaction solution through the first heater.

6. The system of claim 5, wherein first heater is configured to pass the reaction solution to the second heater.

7. The system of claim 6, wherein the outlet of the second heater is configured to pass the reaction solution to a collection container in a continuous manner.

8. The system of claim 7, wherein the system, the first solution, and the second solution are configured to perform a continuous flow synthesis method.

9. The system of claim 7, wherein the system, the first solution, and the second solution are configured to perform a synthesis of inorganic particles and nanoparticles.

10. The system of claim 7, wherein the system, the first solution, and the second solution are configured to perform a synthesis of inorganic particles and nanoparticles of a single phase.

11. The system of claim 7, wherein the system, the first solution, and the second solution are configured to perform a synthesis of inorganic particles and nanoparticles belonging to different phases.

12. The system of claim 7, wherein the system, the first solution, and the second solution are configured to perform a synthesis of inorganic particles and nanoparticles grafted with organic groups.

13. The system of claim 7, wherein the first pump, and the second pump are configured to perform a synthesis based on variable flow rates.

14. The system of claim 13, wherein the first pump and the second pump are configured to vary flow rates of all feeds independently.

15. The system of claim 7, wherein the first pump, and the second pump are configured to vary reaction times based on flow rates.

16. The system of claim 7, wherein a length of tubing in the first heater is configured to control reaction time at a first temperature.

17. The system of claim 7, wherein a length of tubing in the second heater is configured to control reaction time at a second temperature.

18. The system of claim 7, wherein the system, the first solution, and the second solution are configured to influence reaction yield by using different concentrations.

19. The system of claim 7, wherein the first heater, the second heater, the first pump, the second pump, the first solution, and the second solution are configured to synthesize inorganic particles with varying crystallinity.

20. The system of claim 7, wherein the first heater, the second heater, the first pump, and the second pump are configured to vary reaction temperatures.

21. The system of claim 7, wherein the first heater, the second heater, the first pump, and the second pump are configured to vary reaction temperatures to influence phase purity of product.

22. The system of claim 7, wherein the first heater, the second heater, the first pump, and the second pump are configured to vary reaction temperatures to influence crystallinity.

23. The system of claim 7, wherein a length of the first heater and/or a length of the second heater are configured to be increased to increase crystallinity.
